(19) United States
(12) Patent Application Publication
(10) Pub. No.: US 2005/0200163 A1
(43) Pub. Date: Sep. 15, 2005

(54) Motor vehicle fixed window removal system

(76) Inventors: Edward H. Arnold JR., Arroyo Grande, CA (US); Lonny MacDougall, Phoenix, AZ (US)

Correspondence Address: Steven Thrasher, 391 Sandhill Dr., Richardson, TX, 75080, US

(21) Appl. No.: 10/796,637

(22) Filed: Mar. 9, 2004

(51) Int. Cl. B60J 1/02

(52) U.S. Cl. 296/201; 296/96.21

(57) ABSTRACT

The invention is a quick-remove window system that provides for the rapid removal of a window from a motor vehicle. The system includes a motor vehicle window frame, a window disposed in the motor vehicle window frame, a window packing disposed between the window and the window frame, and a cord disposed in the window packing such that when the cord is moved a known length, an amount of the window packing is removed for facilitating removal of the window from the window frame.

### TECHNICAL FIELD

The invention relates to motor vehicles, and, more particularly, the invention relates to motor vehicle windows and windshields.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Motor vehicle (vehicle) windows and windshields increase aerodynamic performance while providing occupant protection from wind, excessive sun glare, and small objects (of course, a windshield is one type of vehicle window). For example, modern windows and windshields are engineered to complement the shape of the vehicle body to enable the vehicle to “cut” through the air. More than being more visually appealing, this increases fuel efficiency. In addition, tinting can help prevent accidents by protecting occupants from the sun's glare, while the structure of the windows and windshield prevents pebbles and insects from pelting occupants. To reliably provide these benefits, and to prevent the theft of items in the vehicle, windshields, and some windows, are rigidly mounted to a vehicle frame. However, the rigid mounting of the windshield and windows to the vehicle frame is not without drawbacks.

For example, persons may become trapped in a vehicle due to a wide variety of circumstances. Sometimes, due to poor driving or to poor road conditions, a person may drive a car into a body of water, such as a reservoir, lake, or flooded street, thereby trapping the occupants of the vehicle inside. In yet other circumstances a vehicle occupant may be trapped inside a car as a result of an accident. Occasionally, vehicles catch fire due to electrical problems or as a result of accidents and burn any occupants who are trapped inside. Whether due to fire, flood, or other trapping, vehicle occupants need a means for escape in the event they are trapped inside and face potential danger. Sometimes, doors and side windows are pinned against objects, or shutdown do to electromechanical failure, leaving the front or rear windshields, and fixed windows, as the only means of escape. Unfortunately, rigid windshields and fixed windows are difficult to remove. Accordingly, there is a need for inventive systems and devices that enable an occupant to have more control over an escape from a motor vehicle. The present invention provides such a system and device.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a quick-remove window system (the window system);

FIG. 2 illustrates a cut view of the quick-remove window system taken along cut line 2-2;

FIG. 3 is an enlarged view of a selected portion the window system, taken in the direction and location of arrow 3;

FIG. 4 shows an automated quick-remove window system (the automated window system); and

FIG. 5 illustrates a cut view of the automated quick-remove window system taken along cut line 5-5.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. The invention is also described in view of the Festo decisions, and, in that regard, the claims and the invention incorporate equivalents known, foreseeable, and unforeseeable.

Discussion of the Figures

The invention can be generally characterized as a system that allows a motor vehicle occupant to remove a rigidly affixed window or windshield, such as a front or rear windshield of an automobile or rear windows of Vans and SUVs to increase vehicle safety and provide a means for lifesaving functionality in the event of vehicle submersion or fire. In one embodiment, the invention provides a manually operable system that uses a cord to remove a substantial amount of packing material from a window or windshield frame so that a window or windshield may be more easily separated from the window or windshield frame. In an alternative embodiment, a plurality of actuators are situated about the window or windshield frame, and a motor is used wrap the cord (thus removing the packing); thus, after the motor-pulled cord removes a portion of the packing material from the frame, the actuators then push the window or windshield from the frame, or alternatively, provide additional force to assist an occupant with the removal of the window or windshield from the vehicle. Of course, it should be understood that the system is not limited by structural implementation, but rather by function.

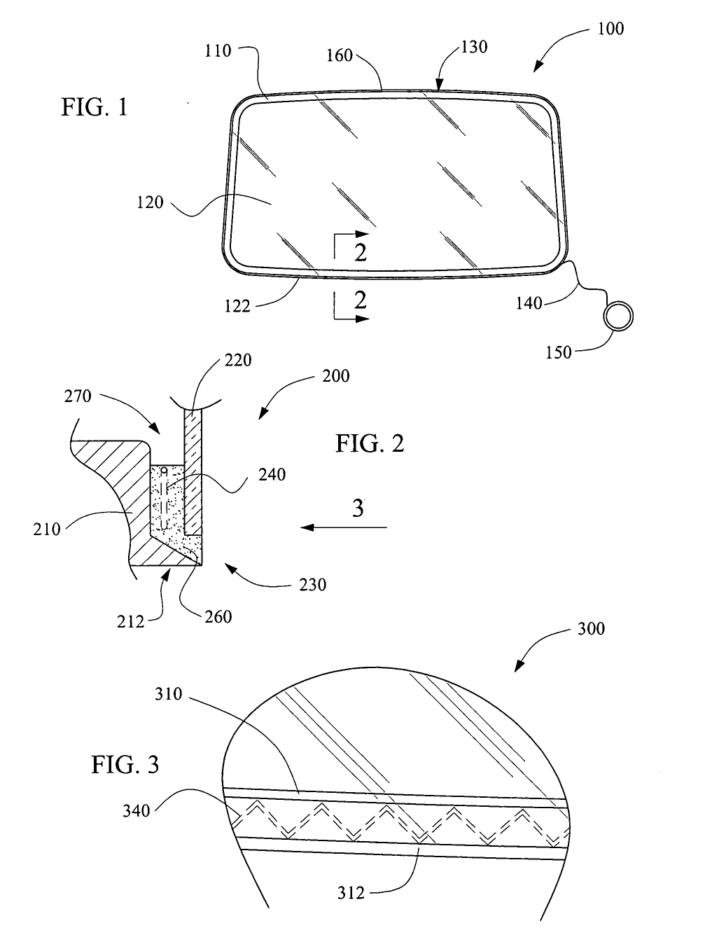

Features and advantages of the invention can be better understood by reviewing the figures in which FIG. 1 shows a quick-remove window system (the window system) 100. The window system 100 generally includes a motor vehicle window or windshield frame (the frame) 110 in which a window or windshield 120 is set. Typically, the frame 110 is slightly larger than the window or windshield 120, and thus a channel 130 is formed by the gap between the frame 110 and the edge of the window or windshield 120. To secure the window or windshield 120 in the frame 110, a packing (or, packing material) 160 fills the channel 130. Inventively, a cord 140 runs through the packing material 160, and a pull-portion 150 may be coupled to the cord 140 so that when the pull portion 150 is pulled, the packing material 160 is removed from the channel 130. Accordingly, the quick-remove window system 100 provides an occupant the ability to rapidly remove a window or windshield from a motor vehicle.

The frame is preferably a separate, uniquely identifiable unit, which is securable in a motor vehicle body as is known in the motor vehicle art. However, the frame 110 may alternatively be formed from a portion of the motor vehicle body. The window or windshield 120 is preferably a known glass window or windshield. However, it is anticipated that alternative windows or windshields will soon come into use, such as acrylic windows or windshields, and shock-absorbing windows or windshields made from a variety of materials. Accordingly, the invention is not limited by the material or structure or unique function of the window or windshield. The packing material 160 is any prior-art packing material, and is preferably a material that cures so that it disintegrates when under a lateral load, such as the load created by the cord 140 being pulled. Packing materials having these qualities are known in the glass arts.

Alternatively, the packing material comprises a first layer of packing material that is highly weather-resistant, and comprises a second layer of packing material that disintegrates under pressure, where the cord 140 runs through the second layer of packing material (which is preferably the layer adjacent to the frame, whereas the first layer of packing material is adjacent to the window or windshield. The cord 140 is of a sufficient strength to break-up the packing material, or of sufficient density or hardness to facilitate the easy removal of the packing, and thus facilitate the removal of the window or windshield.

Accordingly, the cord 140 is disposed in the packing 160 such that when the cord 140 is moved a given length, an approximately and generally predictable amount of the packing is removed. In an alternative embodiment, the cord 140 is sectioned into a plurality of rigid portions. Preferably, each rigid portion corresponds to an up-tick or a downtick in the cord, when the cord 140 is arranged in its preferable saw-tooth pattern. In an alternative embodiment, the system 100 includes a window or windshield seal (not shown) disposed about an exterior portion of a channel defined by a space between the window or windshield and the window or windshield frame edge.

The pull-portion 150 is a structure that assists a user with removing the packing 160 from the system 100. Preferably, the pull-portion 160 is disposed on an interior portion of a motor vehicle, such as proximate to a hood-release. Alternatively, the pull-portion 150 is integrally fitted into a vehicle interior portion, thus forming a portion of a vehicle door or vehicle dash, for example.

FIG. 2 illustrates a cut view of the quick-remove window system 200 taken along cut line 2-2. The FIG. 2 illustration of the system 200 shows the frame 210, the window or windshield 220, packing 260 and cord 240. In addition, from FIG. 2, one sees that the frame 210 preferably includes a lip 212 into which the window or windshield 220 sits. Further, the channel 230 is demonstrated as being the area between the window 220 and the frame, and may comprise at least a portion of the lip 212. Note that the packing 260 may generate a gap (or crevasse) 270 to form between the frame 210 and the window 220.

To provide for a clearer understanding of a preferred embodiment of the invention, FIG. 3 is an enlarged view of a selected portion the window system 200, taken in the direction and location of arrow 3. Here it is seen that the cord 340 is preferably configured to form a saw-tooth pattern, and preferably comprises a plurality of rigid portions. Although not viewable in FIG. 3, it should be understood that each link of the saw-tooth pattern is preferably a rigid portion.

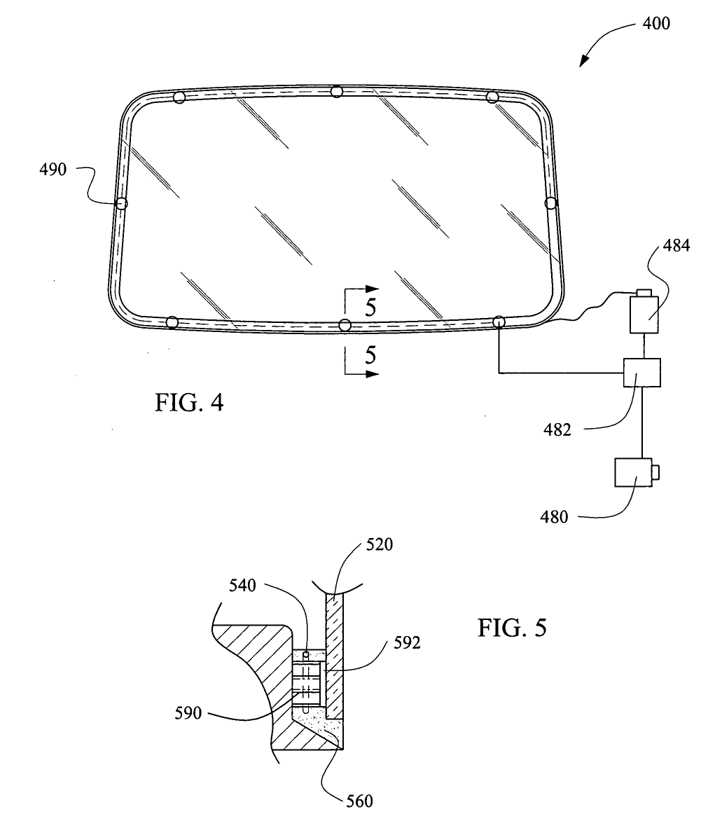

The invention can also be characterized as a system, which, in response to a user input, makes a window or windshield easy to remove. To better understand the embodiments of the invention that achieve this end, FIG. 4 shows an automated quick-remove window system (the automated window system) 400. The system 400 includes a motor vehicle window or windshield frame 110, a window or windshield 120 disposed in the motor vehicle window or windshield frame 110, a window or windshield packing 160 disposed in a channel 130 between the window or windshield 120 and the window or windshield frame 110, and a removal system comprising at least one actuator 490 coupled between the window or windshield frame 110 and the window or windshield 120.

An actuator switch 480, which is preferably located in a vehicle dashboard, is communicatively coupled to at least one actuator 490 and to a motor 484 so that a cord 140 disposed in the packing 160 removes some portion of the packing 160 as the cord 140 is moved in the channel 130. In the present embodiment, the cord 140 is disposed in the channel 130 so that no actuator 490 is moved or removed when the cord 140 is moved.

In the present preferred embodiment, a mechanical assistance system is coupled between the cord and the actuator switch 480, and in the present embodiment includes a motor 484. It should be understood that although not shown in FIG. 4, a manual back up may be provided to insure that if the motor 484 should fail, a user will still be able to dislodge a window or windshield.

Furthermore, a computing system 482 is coupled between the actuator switch 480 and the actuator(s) 490 and the motor 484. The computing system 482 controls the functions of the removal system by actuating the motor 484 to substantially remove the packing 160 (via the cord 140 being substantially removed) prior to initiating the actuators 490. The computing system 482 also controls the application of the force to the window to prevent window cracking, breaking, or dicing. Accordingly, the invention defines a quick-remove window system that provides for the rapid and automatic removal of a window or windshield from a motor vehicle.

FIG. 5 illustrates a cut view of the automated quick-remove window system taken along of cut line 5-5. FIG. 5 shows a worm screw actuator 590 configured to push the window or windshield 520 out of the window or windshield frame 510. Thus, to lower the space required between the window and the frame, the actuator is preferably a worm screw actuator. In addition, the actuator 590 also includes a push plate 592 coupled to the worm screw actuator 590. The push plate 592 disperses the forces generated by the worm screw actuator 590 across a larger area of the window or windshield 520.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A quick-remove system that provides for the rapid removal of a window or windshield from a motor vehicle, comprising:
a motor vehicle window frame;
a window disposed in the motor vehicle window frame;
a window packing disposed between the window and the window frame; and
a cord disposed in the windshield packing such that when the cord is moved a known length, an amount of the windshield packing is removed for facilitating removal of the windshield from the windshield frame.

2. The system of claim 1 wherein the window is a windshield.

3. The system of claim 1 wherein the cord comprises fiberglass.

4. The system of claim 1 wherein the cord is sectioned into a plurality of rigid portions.

5. The system of claim 1 further comprising a mechanical assistance system coupled to the cord.

6. The system of claim 1 further comprising a removal system coupled to the cord.

7. The system of claim 1 further comprising a window seal disposed about an exterior portion of a channel defined by a space between the window and the window frame edge.

8. The system of claim 1 wherein the pull-portion is disposed on an interior portion of the motor vehicle.

9. The system of claim 1 wherein the pull-portion is integrally fitted into a vehicle interior portion.

10. The system of claim 1 wherein the pull-portion is mounted in a motor vehicle dash.

11. The system of claim 1 further comprising a motor coupled between an actuator and the cord, the motor adapted to pull the cord.

12. The system of claim 12 further comprising an actuator switch coupled to the motor, the actuator switch located in an interior portion of the vehicle.

13. The system of claim 1 further comprising at least one actuator coupled to the actuator switch, the actuator adapted to push the window out of the window frame.

14. The system of claim 13 wherein the actuator is a worm screw actuator.

15. The system of claim 14 wherein the actuator further comprises a push plate coupled to the worm screw actuator.

16. The system of claim 14 further comprising a computing system coupled between the actuator switch and the actuator.

17. A quick-remove window system that provides for the rapid and automatic removal of a window from a motor vehicle, comprising:
a motor vehicle window frame;
a window or disposed in the motor vehicle window frame;
a window packing disposed between the window and the window frame;
at least one actuator coupled between the window frame and the window;
an actuator switch communicatively coupled to an actuator;
a cord disposed in the window packing such that when the cord is moved a known length, an amount of the window packing is removed for facilitating removal of the window from the window frame;
the cord also disposed so that no actuator is removed when the cord is pulled; and
a mechanical assistance coupled between the cord and the actuator switch.
